(19) United States
(12) Patent Application Publication
(10) Pub. No.: US 2009/0112755 A1
(43) Pub. Date: Apr. 30, 2009

(54) METHOD AND SYSTEM FOR ON-LINE AGENCY DISBURSEMENT MANAGEMENT OF EXPENSES FOR INTELLECTUAL PROPERTY RIGHTS

(75) Inventor: Wei-Chieh LIN, Taichung City (TW)

Correspondence Address: EGBERT LAW OFFICES, 412 MAIN STREET, 7TH FLOOR, HOUSTON, TX, 77002, US

(73) Assignee: IPFEE INTELLECTUAL PROPERTY ADMINISTRATE Co., Ltd., Taichung City (TW)

(21) Appl. No.: 11/928,789

(22) Filed: Oct. 30, 2007

(51) Int. Cl. G06Q 20/00; G06F 19/00

(52) U.S. Cl. 705/39

(57) ABSTRACT

The present invention provides a method and system for on-line agency disbursement management of expenses for intellectual property rights. A payment management website is built-into a host computer and linked to Internet by the business terminal. The payment management website includes a login module, so that the client can log in the payment management website to operate the login module and access the data of intended intellectual property right cases through the operating screen of login module. The business terminal can pay the intellectual property right expenses to the government body or entrusted organizations. The payment management website is fitted with a management module linked to the login module, so that the client can learn about the disbursement state of intellectual property right expenses and/or the situation of intellectual property right cases. The expenditure of the client and subsequent control cost and risks are considerably reduced.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a disbursement service, and more particularly to an innovative service with a method and system for on-line agency disbursement management of expenses for intellectual property rights.

2. Description of Related Art Including Information Disclosed Under 37 CFR 1.97 and 37 CFR 1.98.

The expenses for intellectual property rights, referred to in the present invention, comprise: patent annuities, patent maintenance fees and trademark registration fees payable to the competent authorities. There are also compulsory procedure fees of other intellectual property rights.

The typical payment methods for intellectual property right owners (hereinafter referred to as a “client”) and consequential shortcomings are described below:

The client can pay the expenses for intellectual property rights via the agents of an intellectual property right, such as a patent & trademark attorney, hereinafter referred to as an “agent”). Such a payment method avoids tangled procedures, and the agent is able to prevent incorrect payment and duly obtain the next payment deadline with their expertise. The shortcoming of this method is that the client must pay a great sum of commission fees, leading to much higher costs of payment.

The agents of intellectual property rights generally pay the expenses to the government after obtaining the consent and disbursement confirmation of the clients. Then, payment by the client is required through common procedures. After receiving the request and disbursement voucher from the agents, the clients send a check with a proper time limit to the agent. Though the agents are entitled to charge the clients for service commissions of intellectual property rights, the agents have to bear the cost of disbursement cash, HR cost, potential risk for undue or refusal of payment by clients or dishonored payment as well as subsequent management cost and loss of interest from disbursement.

If the agents increase the service commissions of intellectual property rights to minimize the business risk and cost, they will face the peer competition and loss of clients, leading to sharp decline of market competitiveness.

Alternatively, the client can also pay the expenses for intellectual property rights by himself. This payment method eliminates the agency fees. The shortcomings of this method is that the client unfamiliar with the laws of intellectual property rights will have to face the potential risk of false payment, or even lose the right due to late payments. In spite of convenient measures offered by the competent authorities of various countries for payment, the client may find it difficult to remember the annual payment deadlines, not to mention that different payment deadlines apply to several intellectual property rights. Notwithstanding the duty to notify the clients by the competent authorities, overdue payment may occur due to failure to receive mail by the clients. To address the aforementioned problems, the clients have to employ some personnel to control the payment deadlines and procedures for intellectual property right annuities. In such case, the personnel cost of the clients will increase costs much higher than the agency fee. Furthermore, if the person in charge of intellectual property right expenses resigns from his position, the clients cannot properly manage the payment of intellectual property right expenses.

The competent authorities, hereinafter referred to as “government”, encourage the clients to pay the expenses of intellectual property rights by themselves. Another shortcoming of this method is that the government has to bear the cost of notifying the clients and instructing them to pay the expenses. Also, in the case of false payment or unclear or error filling by the clients due to insufficient expertise, the government must notify the clients to amend it and mail the payment vouchers to them, thus leading to a greater work load and higher cost of personnel and mailing, etc.

Thus, to overcome the aforementioned problems of the prior art, it would be an advancement in the art to provide an improved system that can significantly improve efficacy.

Therefore, the inventor has provided the present invention of practicability after deliberate design and evaluation based on years of experience in the production, development and design of related products.

### BRIEF SUMMARY OF THE INVENTION

Based upon an innovative method and system of on-line disbursement management of expenses for intellectual property rights, the client will eliminate the problems of miscellaneous procedures and false payment. Moreover, with the expertise of business terminal disbursement and the operation of an internal management module, the subsequent payment of client intellectual property right expenses can be controlled without the need of notifying the client for payment or disbursement for the client. So the business terminal can sharply reduce the waste of the work force and risks of disbursement or bad debts. Then, the business terminal can feed back the reduced operating cost to the client, namely, minimizing the commissions arising from disbursement and control of intellectual property right expenses. So, the client can sharply cut the cost of disbursement and subsequent control of intellectual property right expenses while the business terminal can obtain proper operating profit. As the business terminal provides an economical, professional and straightforward on-line trading path, it is possible to improve the entrust desire and market competitiveness of the client for two-win purposes.

With the management module of the present invention, the data of intellectual property right cases accessible from a login module can be displayed, allowing the client to know about the disbursement state of intellectual property right expenses and/or the situation of intellectual property right cases. So, the client can inquire about if the subsequent payment procedure has finished, and the client can fully understand the status of intellectual property right cases. Moreover, the data can be real-time accessed conveniently and efficiently, thus greatly improving the efficiency of the client's managerial staff.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a block diagram illustration of the on-line agency disbursement management method for the intellectual property right expenses of the present invention.

FIG. 2 shows another diagram illustration with an abbreviated view of the on-line agency disbursement management method and system for expenses of an intellectual property right of the present invention.

FIG. 3 shows a partial illustration showing various units of a data control module in on-line agency disbursement management system for the intellectual property right expenses of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

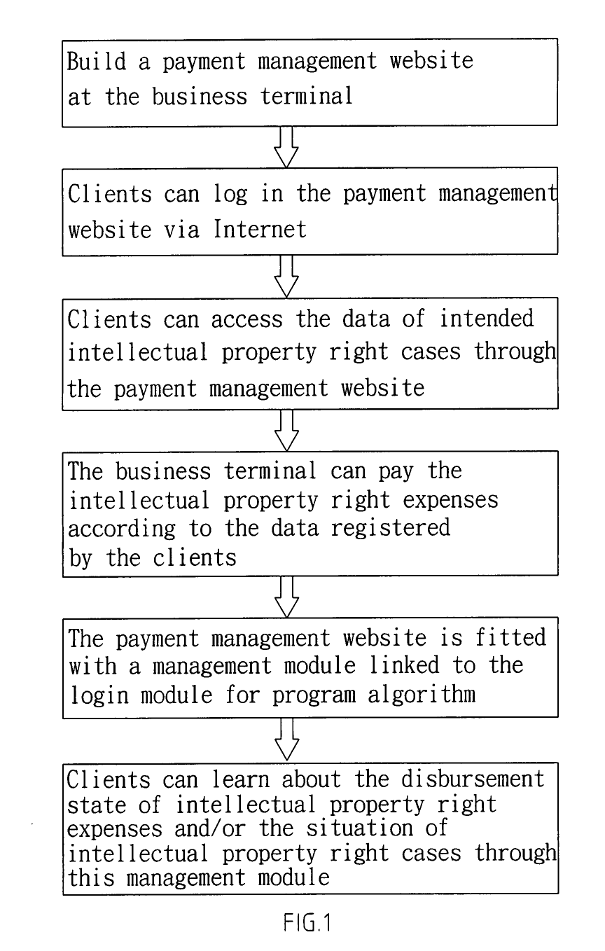

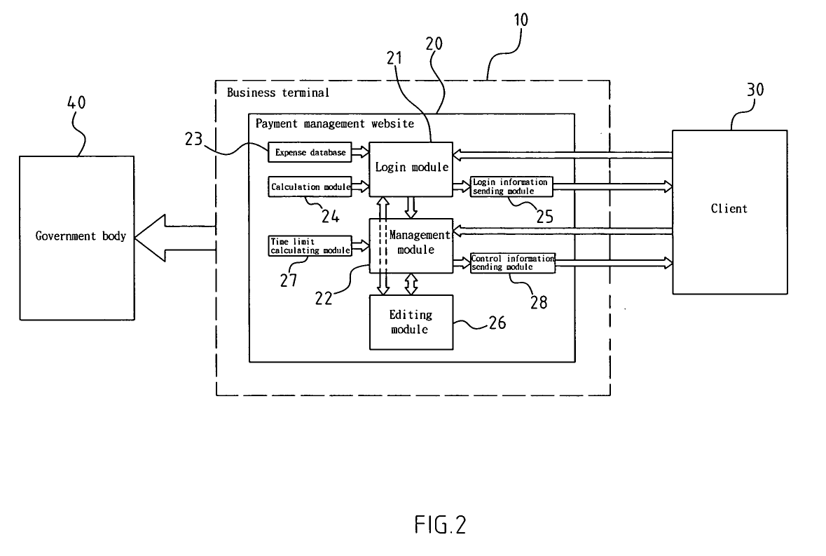

The method and system for on-line agency disbursement management of expenses for intellectual property rights refer to a method and system whereby the agents, entrusted by the clients, pay the expenses of intellectual property rights through Internet for the clients and control the relevant data by certain payment means. Referring to FIGS. 1 and 2, the system comprises at least a business terminal 10, a payment management website 20 built-into a host computer or server and linked to Internet. A login module 21 is loaded onto the payment management website 20, so that the client 30 can log in the payment management website 20 to operate the login module 21 and to access the data of intended intellectual property right cases through the operating screen of login module 21. The website is made available through the business terminal 10. The business terminal 10 can pay the intellectual property right expenses entrusted by the client 30 to the government body 40 (e.g. Intellectual Property Office of the Ministry of Economic Affairs) or entrusted organizations. Moreover, the payment management website 20 is fitted with a management module 22 linked to the login module 21, so that the client 30 can learn about the disbursement state of intellectual property right expenses and/or the situation of intellectual property right cases through this management module 21.

The disbursement state indicates whether business terminal 10 receives the disbursement expense entrusted by the client 30 or whether the business terminal performs or finishes the disbursement. The situation of intellectual property right cases indicates if the expenses of intellectual property right cases logged-in by the client 30 are paid within compulsory payment deadline. The compulsory payment term refers to the time limit of compulsory payment and/or the date of next compulsory payment.

The expenses of intellectual property right cases comprise patent annuities and/or trademark registration fees payable to the government body 40.

Each intellectual property right cases contain the following data:
1. Application, certification, publication, or bulletin number;
2. Name of owner;
3. Name of intellectual property right;
4. Country of the intellectual property right;
5. Type of intellectual property right; and
6. Period of payment of intellectual property right.
   The data of the aforementioned intellectual property right cases are displayed in fields in the login module 21. Some customized optional items (e.g. country, type and period of payment of intellectual property right) are represented individually, so the client can simply select them by clicking.

The payment management website 20 comprises an expense database 23 and a calculation module 24 linked to the login module 21, which calculate and make statistics of the expenses to be paid by the client 30. As for the patent annuity, if the expense of every intellectual property right case entrusted by the client 30 contains the compulsory fees payable to the government body 40 and commissions payable to business terminal 10, the amount of compulsory fees and commissions of various patents (e.g. inventions, utility models and new styles) must be loaded in the expense database 23. Given the fact of single or multiple patent cases to be entrusted by the client 30 through login module 21, it is required to confirm the login data, calculate and make statistics of all expenses through said calculation module 24 and then notify immediately the client 30.

The payment management website 20 also comprises a login information sending module 25 linked to the login module 21, so that the login information and/or payment message can be sent automatically to the client through login information sending module 25 after the client 30 enters the data of intellectual property right cases. The payment message at least comprises the compulsory sum of intellectual property right expenses payable to the government body 40, and the relevant message on how the client 30 pays to business terminal 10. Subsequently, the client 30 shall, according to the payment message, employ the existing payment means to pay the expenses to the business terminal 10 prior to the scheduled deadline. The payable expenses comprise the compulsory fees payable to the government body 40 and commissions payable to business terminal 10. The payment means can be implemented fully or partially by the following methods: mailing of check, cash, remittance, payment by credit cards, funds transfer or ATM, Internet-based credit card, e-commerce payment center or log-in to access credit card data via mobile phones as well as disbursement by e-currency.

The payment management website 20 also comprises an editing module 26 linked to the login module 21 and management module 22, so that the data of intellectual property right cases are displayed through the editing module 26, making available to the business terminal 10. Furthermore, the business terminal 10 can edit the data of intellectual property right cases through the editing module 26.

The payment management website 20 also comprises a time limit calculating module 27 linked to the management module 22. The time limit calculating module 27 is provided with time limit setting value, whereby time limit control and automatic state updating of the intellectual property right cases are possible.

The payment management website 20 also comprises a control information sending module 28 linked to management module 22, so that the control information can be sent to the client 30 according to the state of intellectual property right cases, the preset abnormal state and updating time. For example, after the business terminal 10 finishes disbursement procedures, a paid message is sent back to the client 30 through the control information sending module 28. The paid message comprises the name of payer, account number of paying bank, amount, date of payment and receipt voucher of competent authorities. So, the client 30 is informed of the disbursement of intellectual property right expenses to the government body 40.

The login module 21 comprises a paid log-in unit, which provides detailed data of payment to the business terminal 10, such as amount of payment, date and transfer account number.

The payment management website 20 also comprises an inquiry display unit for intellectual property right expenses, so that the client 30 and business terminal 10 can inquire about the amount paid to the government body. The inquiry display unit can also display the amount of disbursement commissions for the business terminal 10. The inquiry display unit for intellectual property right expenses is presented in forms by the name of country, and type of intellectual property right (e.g. inventions, utility models and new patents).

The system of the present invention is loaded into the host computer or server, and also linked to Internet. Referring to FIG. 2, the payment management website 20 mainly comprises a login module 21, a management module 22 and an editing module 26.

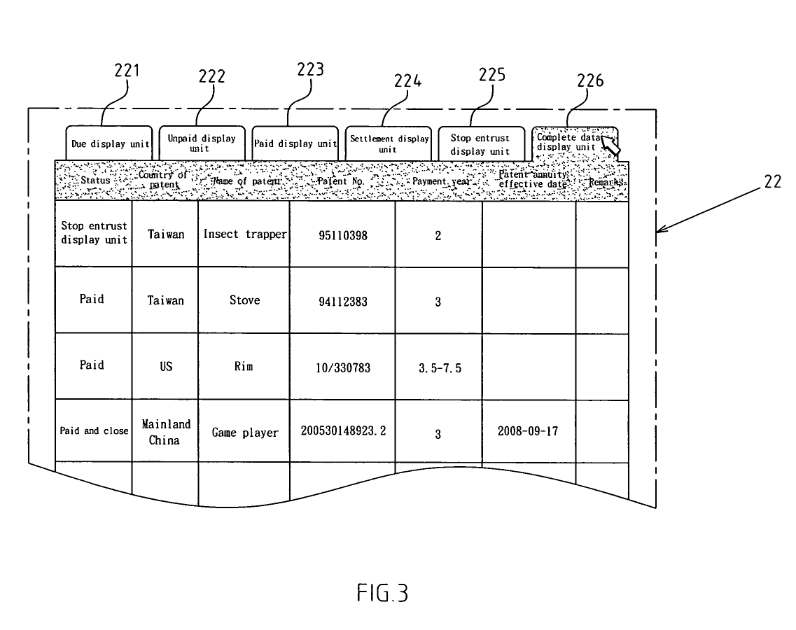

The management module 22 allows the client to know about the disbursement state of intellectual property right expenses and/or the situation of intellectual property right cases through this management module. The management module 22 is divided into the following units for the client (shown in FIG. 3):
a due display unit 221, which is used to display the compulsory payment deadline of the client, namely due payment date of intellectual property right expenses;
an unpaid display unit 222, which is used to display the data indicating that the client has logged in through the login display module 61, but not yet paid the expenses to the business terminal;
a paid display unit 223, which is used to display the data indicating that the client has logged in through the login display module 61, and the business terminal has received the money;
a settlement display unit 224, which is used to display the data indicating that the business terminal has already finished disbursement procedure for the client;
a stop entrust display unit 225, which is used to display the data indicating that the client is not allowed for disbursement since he/she has not finished the entrust procedure within effective period specified by the business terminal; and
a complete data display unit 226, which is used to display the data indicating all login data of the client in login display module 61.

Various units of the data control module 63 are set into different selection blocks. When these blocks are selected, the data of the corresponding units can be accessed. FIG. 3 depicts the state indicating “all display” units are selected by cursor, so the following tables show all login data of the client in login display module 61.

Additionally, the aforementioned time limit calculating module 27 is operated in collaboration with the concrete units of the management module 22. The intellectual property right cases in the settlement display unit 224 will be subject to the payment control procedure of next phase, during which the time limit calculating module 27 is designed with several time limit setting value, for example, the compulsory time limit of next payment, and time point prior to 30 days and 60 days of next payment. At the time point prior to 30 days and 60 days of next payment, the data of intellectual property right cases in the settlement display unit 224 will be automatically transferred into due display unit 221, meanwhile a notification message will be updated and sent automatically to the client through the control information sending module 28. However, if the client has not yet entrusted the business terminal for disbursement after the time point of next compulsory payment time limit, the data of intellectual property right cases will be updated and transferred automatically into stop entrust display unit 225 from the due display unit 221, meanwhile a stop entrust message is sent to the client through the control information sending module 28. Certainly, the client can also log in the payment management website and then various units of the management module 22 to obtain the current state of intellectual property right cases (shown in FIG. 3).

1. A method for on-line agency disbursement management of expenses for intellectual property right, said method comprising:
building a payment management website into a host computer and linking the website to the Internet by a business terminal;
loading a login module onto said payment management website, a client logging in said payment management website to operate said login module, to access data of intended intellectual property right cases through an operating screen of said login module, and to make the website available to said business terminal;
paying the intellectual property right expenses to a government body or entrusted organization through said business terminal; and
fitting the payment management website with a management module linked to said login module, a disbursement state of intellectual property right expenses and a situation of intellectual property right cases or both being available to said client through said management module.

2. The method defined in claim 1, wherein said intellectual property right cases contain data comprising:
application, certification, publication, or bulletin numbers;
name of owner;
name of intellectual property right;
country with intellectual property right;
type of intellectual property right; and
period of payment of the intellectual property right.

3. The method defined in claim 1, wherein said payment management website comprises an expense database and a calculation module linked to said login module, calculating and making statistics of expenses to be paid by the client.

4. The method defined in claim 1, wherein said payment management website further comprises a login information sending module linked to said login module, the login information and/or payment message being sent automatically to the client through said login information sending module after the client enters data of intellectual property right cases.

5. The method defined in claim 1, wherein said payment management website further comprises an editing module linked to said login module and said management module, data of intellectual property right cases being displayed through said editing module, being made available to said business terminal, said business terminal editing said data of intellectual property right cases through said editing module.

6. The method defined in claim 1, further comprising:
indicating whether said business terminal receives disbursement expense entrusted by the client or whether said business terminal performs or finishes disbursement in said disbursement state.

7. The method defined in claim 1, further comprising:
indicating whether expenses of intellectual property right cases logged-in by the client are paid within a compulsory payment deadline, in said situation of intellectual property cases, said compulsory payment term referring to a time limit of compulsory payment or a date of next compulsory payment or both.

8. The method defined in claim 1, further comprising:
linking a time limit calculating module to said management module, in said payment management website, said time limit calculating module being provided with a time limit setting value, whereby time limit control and an automatic state updating the intellectual property right cases.

9. The method defined in claim 1, further comprising:
linking a control information sending module to said management module in said management website, control information being sent to the client according to a state of intellectual property right cases, a preset abnormal state and updating time.

10. A system for on-line agency disbursement management of expenses for intellectual property right, said system being loaded into a host computer and linked to the Internet, said system comprising:
a login module, having a guide for a client to log in, to access data of intellectual property right cases, and to display payable expenses;
a management module, being linked to said login module and used to display the data of intellectual property right cases, allowing the client to know a disbursement state of intellectual property right expenses or a situation of intellectual property right case or both.

11. The system defined in claim 10, wherein said login module contains input fields of intellectual property right cases, said input fields being labeled as:
application, certification, publication, or bulletin numbers;
name of owner;
name of intellectual property right;
country with intellectual property right;
type of intellectual property right; and
period of payment of the intellectual property right.

12. The system defined in claim 10, further comprising:
an expense database and a calculation module linked to said login module, calculating and making statistics of expenses to be paid by the client.

13. The system defined in claim 10, further comprising:
an inquiry display unit for intellectual property right expense, the client and business terminal being able to inquire about an amount of intellectual property right expenses paid to a government body.

14. The system defined in claim 10, further comprising:
a login information sending module linked to said login module, login information or payment message or both being sent automatically to the client through said login information sending module after the client enters the data of intellectual property right cases.

15. The system defined in claim 10, further comprising:
an editing module linked to said login module and a management module, the data of intellectual property right cases being displayed through said editing module, and being made available to said business terminal, said business terminal editing the data of intellectual property right cases through said editing module.

16. The system defined in claim 10, wherein said disbursement state indicates if business terminal receives disbursement expense entrusted by the client or business terminal performs or finishes disbursement.

17. The system defined in claim 10, wherein said situation of intellectual property right cases indicates if expenses of intellectual property right cases logged-in by the client are paid within a compulsory payment deadline, said compulsory payment term referring to a time limit of compulsory payment or the or a date of a next compulsory payment or both.

18. The system defined in claim 10, further comprising:
a time limit calculating module linked to said management module, said time limit calculating module being provided with a time limit setting value, time limit control and automatic state updating of the intellectual property right cases being possible.

19. The system defined in claim 10, further comprising:
a control information sending module linked to said management module, control information being sent to the client according to state of intellectual property right cases, a preset abnormal state and updating time.
